(19) United States
(12) Patent Application Publication
(10) Pub. No.: US 2023/0226869 A1
(43) Pub. Date: Jul. 20, 2023

(54) PRELOAD COLLAR FOR A VEHICLE SUSPENSION SYSTEM

(71) Applicant: Westcott Designs Inc., Cave Creek, AZ (US)

(72) Inventors: Jeffrey Richard Westcott, Cave Creek, AZ (US); Joshua Allen Fleury, Peoria, AZ (US)

(21) Appl. No.: 18/097,582

(22) Filed: Jan. 17, 2023

Related U.S. Application Data
(60) Provisional application No. 63/301,072, filed on Jan. 20, 2022.

(51) Int. Cl. B60G 15/06; B60G 17/027

(52) U.S. Cl. CPC B60G 15/063; B60G 17/0272; B60G 2204/1242; B60G 2202/312; B60G 2206/931

(57) ABSTRACT

A preload collar for a vehicle spring is described. The preload collar is coupled to the shock absorber of a vehicle so that the lower end of the vehicle spring is pressing against the preload collar. The preload collar does not allow the lower end of the vehicle spring to extend toward the ground, or toward the lower end of the shock absorber, as much as it normally would. This pre-loading of the vehicle spring provides suspension lift to the vehicle.

### CROSS REFERENCE TO RELATED APPLICATION[S]

This claims priority to U.S. Provisional Patent Application entitled “PRELOAD COLLAR FOR A VEHICLE SUSPENSION SYSTEM,” Ser. No. 63/301,072, filed Jan. 20, 2022, the disclosure of which is hereby incorporated entirely herein by reference.

### BACKGROUND OF THE INVENTION

### Technical Field

This invention relates to vehicle suspension systems and, specifically, to a preload collar device that pre-loads a vehicle suspension spring in order to provide lift to the vehicle body.

### State of the Art

The vehicle suspension springs of a vehicle suspension system couple the wheels of a vehicle to the body of the vehicle. Vehicle suspension springs, together with the other components of the vehicle suspension system, dampen the motion that the vehicles tires undergo during travel, so that the vehicle body has a smoother ride. Vehicle suspension springs are often used to provide lift to a vehicle body, lifting the body higher relative to the wheels and to the ground. Lifting a vehicle body, as well as optimizing the ride performance, is often difficult to do with stock springs of a vehicle. What is needed is a simple and effective device that couples to a vehicle stock spring to add lift to the vehicle.

### BRIEF DESCRIPTION OF THE DRAWINGS

FIG. 1 shows a preload collar according to the invention in use on a vehicle;

FIGS. 2, 3 and 4 show a preload collar according to the invention; and

### DESCRIPTION OF EMBODIMENTS OF THE INVENTION

As discussed above, embodiments of the invention relate to vehicle suspension systems and specifically to a preload collar device that pre-loads a vehicle suspension spring in order to provide lift to the vehicle body.

Disclosed is a vehicle suspension system, the vehicle suspension system comprising: a preload collar; a shock absorber; and a vehicle suspension spring, wherein the preload collar is fixedly coupled to the shock absorber during use. The preload collar may be shaped as an annular ring of shaped material. The shaped material may be aluminum. The shock absorber may extend through the annular ring. The preload collar may stop a bottom end of the vehicle suspension spring to extend to a lower end of the shock absorber. The preload collar may compress the vehicle suspension spring away from a lower end of the shock absorber, and wherein the vehicle suspension spring is forced towards an upper end of the shock absorber. The annular ring may comprise a lip. The lip may catch a bottom end of the vehicle suspension spring.

Disclosed is a vehicle having a vehicle suspension system which comprises: the vehicle suspension system having a preload collar, a shock absorber; and a vehicle suspension spring, wherein the preload collar is fixedly coupled to the shock absorber during use; a vehicle body; and a vehicle axle, wherein the vehicle body is lifted relative to the vehicle axle and ground.

Disclosed is a method of adding suspension lift to a vehicle, wherein a vehicle body is lifted relative to a vehicle axle and ground comprising: coupling a preload collar having an annular ring to a shock absorber; and compressing a vehicle suspension spring with the preload collar away from a lower end of the shock absorber forcing the vehicle suspension spring towards an upper end of the shock absorber.

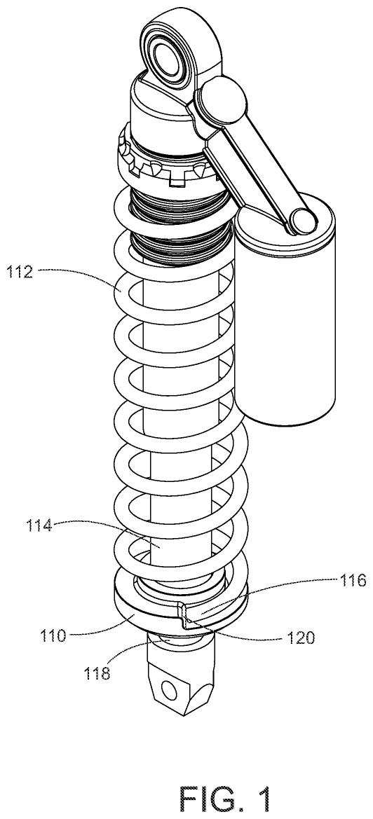

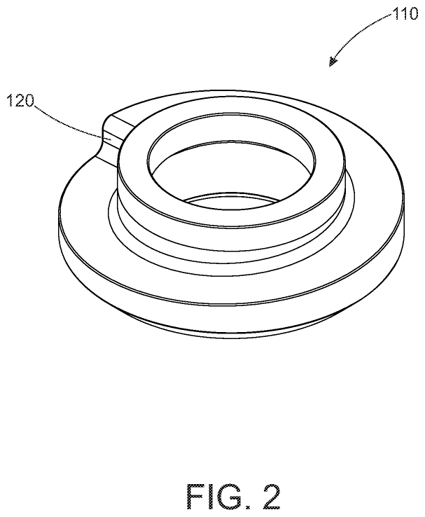

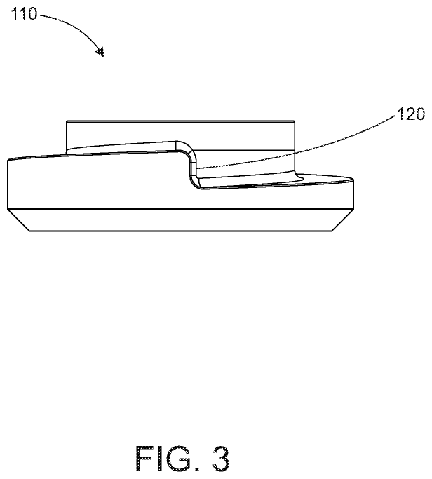

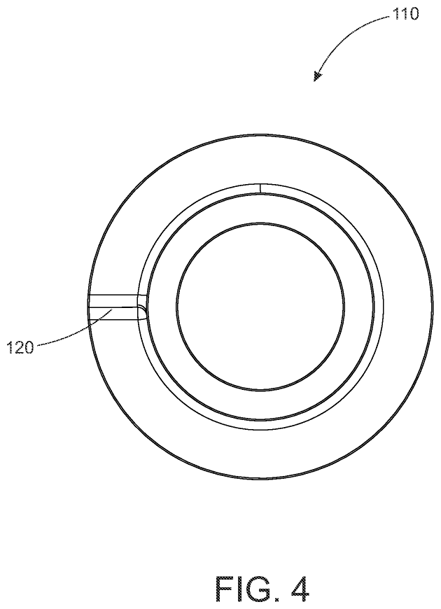

It is often desirable to add suspension lift to a vehicle, where the vehicle body is lifted relative to the wheels and the ground. Suspension lift is often added to a vehicle by using the suspension system of a vehicle to lift the vehicle body relative to the wheels. A preload collar 110 has been invented that simply and easily pre-loads a vehicle suspension spring 112 to provide lift to a vehicle body. FIG. 1 and FIG. 2 show a preload collar 110 according to the invention coupled to a shock absorber 114 of a vehicle to add lift to the vehicle body. FIGS. 3A, 3B, 3C and 3D show preload collar 110 used in FIG. 1 and FIG. 2.

Preload collar 110 is an annular ring of shaped material, such as shaped aluminum. Shock absorber 114 extends through preload collar 110, and preload collar 110 is coupled to shock absorber 114 so that preload collar 110 does not move on shock absorber 114 during use, i.e., fixedly coupled. A bottom end 116 of vehicle suspension spring 112 rests against preload collar 110, as seen in FIG. 1 and FIG. 2. Preload collar 110 does not allow bottom end 116 of spring 112 to extend to a lower end 118 of the shock absorber 114. Preload collar 110 pre-loads, or compresses, spring 112 away from lower end 118 of shock absorber 114, forcing spring 112 towards an upper end of shock absorber 114, raising vehicle body 122 with respect to axle 124 and vehicle wheels (not shown), and thus providing suspension lift to the vehicle. The upper end of shock absorber 114 is not shown, but the upper end of shock absorber 114 opposes lower end 118 of shock absorber 114

Preload collar 110 is shown in use with a stock (provided with the vehicle) shock absorber 114 but can be used with many different types and size of shock absorbers. Preload collar 110 is shown providing suspension lift but can be used to preload spring 112 for many different reasons.

Preload collar 110 is shaped with a lip 120, also known as a catch, or abutment, as shown in the figures. Lip 120 catches bottom end 116 of spring 112, as best seen in FIG. 2, keeping spring 112 from rotating on shock absorber 114.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above.

1. A vehicle suspension system, the vehicle suspension system comprising:
a preload collar;
a shock absorber; and
a vehicle suspension spring, wherein the preload collar is fixedly coupled to the shock absorber during use.

2. The vehicle suspension system of claim 1, wherein the preload collar is shaped as an annular ring of shaped material.

3. The vehicle suspension system of claim 2, wherein the shaped material is aluminum.

4. The vehicle suspension system of claim 2, wherein the shock absorber extends through the annular ring.

5. The vehicle suspension system of claim 1, wherein the preload collar stops a bottom end of the vehicle suspension spring to extend to a lower end of the shock absorber.

6. The vehicle suspension system of claim 1, wherein the preload collar compresses the vehicle suspension spring away from a lower end of the shock absorber, and wherein the vehicle suspension spring is forced towards an upper end of the shock absorber.

7. The vehicle suspension system of claim 2, wherein the annular ring comprises a lip.

8. The vehicle suspension system of claim 7, wherein the lip catches a bottom end of the vehicle suspension spring.

9. A vehicle having a vehicle suspension system which comprises:
the vehicle suspension system having a preload collar, a shock absorber; and a vehicle suspension spring, wherein the preload collar is fixedly coupled to the shock absorber during use;
a vehicle body; and
a vehicle axle, wherein the vehicle body is lifted relative to the vehicle axle and ground.

10. A method of adding suspension lift to a vehicle, wherein a vehicle body is lifted relative to a vehicle axle and ground comprising:
coupling a preload collar having an annular ring to a shock absorber; and
compressing a vehicle suspension spring with the preload collar away from a lower end of the shock absorber forcing the vehicle suspension spring towards an upper end of the shock absorber.
